(19) United States
(12) Patent Application Publication
(10) Pub. No.: US 2017/0285244 A1
(43) Pub. Date: Oct. 5, 2017

(54) PLANAR ILLUMINATION DEVICE

(71) Applicant: MINEBEA MITSUMI INC., Kitasaku-gun (JP)

(72) Inventor: Takahito YOSHIDA, Fukuroi (JP)

(73) Assignee: MINEBEA MITSUMI INC., Kitasaku-gun (JP)

(21) Appl. No.: 15/476,131

(22) Filed: Mar. 31, 2017

(30) Foreign Application Priority Data
Apr. 4, 2016 (JP) 2016-075025

(51) Int. Cl. F21V 8/00

(52) U.S. Cl. CPC G02B 6/0036; G02B 6/0055; G02B 6/0016; G02B 6/0051; G02B 6/0053; G02B 6/0088

(57) ABSTRACT

A planar illumination device includes a light guide plate guiding a light entering from a light-entering end surface and emitting the light from a light-emission surface, and a fixing member disposed in a manner covering at least an area in the light-entering end surface side of the light-emission surface. The light guide plate has a plurality of first prisms formed on the light-emission surface in the area covered by the fixing member in the light-entering end surface side and a plurality of second prisms formed on the light-emission surface in an area covered by no fixing members. The number of second prisms per unit length in the width direction is smaller than the number of first prisms per unit length in the width direction. Each of the second prisms is formed successively to any of the first prisms in a top view.

### CROSS-REFERENCE TO RELATED APPLICATION(S)

The present application claims priority to and incorporates by reference the entire contents of Japanese Patent Application No. 2016-075025 filed in Japan on Apr. 4, 2016.

### BACKGROUND OF THE INVENTION

### 1. Field of the Invention

The present invention relates to a planar illumination device.

### 2. Description of the Related Art

Planar illumination devices are used as a backlight of a liquid crystal display panel in a liquid crystal display device. Side-light planar illumination devices in which a light source including a light-emitting element such as a light emitting diode(LED) and a light guide plate are assembled are widely used for small mobile information apparatuses such as a mobile phone (see Japanese Patent Application Laid-open No. 2004-354727, for example).

Such a planar illumination device includes a frame-like light-shielding member for defining an effective area for light emission. For a size reduction and sophistication in design, a frame width reduction, that is, a reduction in the width of the shielding member has been requested of the planar illumination device. For example, Japanese Patent Application Laid-open No. 2013-171723 describes a planar illumination device in which a frame width reduction is achieved in two sides perpendicular to a light-entering side (the side with the light source) of the light guide plate.

In addition to a frame size reduction in the two sides perpendicular to the light-entering side of the light guide plate, a frame size reduction in the light-entering side is being requested. The inventors of the present invention therefore made a planar illumination device using a shielding member, the frame width of which was reduced, and found that an area of higher brightness (high brightness area) in a cross shape was problematically generated in the light-entering side, which spoiled the appearance of the device.

### SUMMARY OF THE INVENTION

It is an object of the present invention to at least partially solve the problems in the conventional technology.

A planar illumination device according to an embodiment includes a plurality of light sources, a light guide plate, and a fixing member. The light guide plate has a light-entering end surface, two main surfaces and an opposite end surface, a light emitted from each of the plurality of light sources entering the light-entering end surface, the two main surfaces intersecting with the light-entering end surface and facing each other, the opposite end surface facing the light-entering end surface and the light guide plate guiding the entering light toward the opposite end surface and emitting the entering light from a light-emission surface that is one of the two main surfaces. The fixing member is disposed in such a manner that covers at least an area in the light-entering end surface side of the light-emission surface of the light guide plate. The light guide plate has a plurality of first prisms and a plurality of second prisms, the plurality of first prisms being formed on the light-emission surface of the light guide plate in such a manner that extends toward the opposite end surface in an area covered by the fixing member in the light-entering end surface side and the plurality of second prisms being formed on the light-emission surface of the light guide plate in such a manner that extends toward the opposite end surface in an area in the opposite end surface side with respect to the area covered by the fixing member in the light-entering end surface side. Number of the plurality of second prisms per unit length in a width direction of the light guide plate is smaller than number of the plurality of first prisms per unit length in the width direction. Each of the plurality of second prisms is connected with any of the plurality of first prisms in a prism extending direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view schematically illustrating a planar illumination device according to an embodiment;

FIG. 2 is an illustrative top view of a light source and a light-entering end surface and a light-entering prism of a light guide plate;

FIGS. 3A to 3D are illustrative views of a first prism and a second prism;

FIGS. 4A to 4C are illustrative views of a reason why a high brightness area in a cross shape is generated in a conventional technique and of an advantageous effect of preventing the generation in this embodiment;

FIG. 5 is an illustrative view of an exemplary method of fabricating a molding member used for fabricating the light guide plate illustrated in FIGS. 3A to 3D;

FIG. 6 is an illustrative side view of the light guide plate in another embodiment;

FIG. 7 is an illustrative view of an exemplary method of fabricating a molding member used for fabricating the light guide plate illustrated in FIG. 6; and

FIG. 8 is an illustrative top view of the light guide plate in still another embodiment.

### DETAILED DESCRIPTION OF THE PREFERRED EMBODIMENTS

An embodiment of a planar illumination device according to the present invention will now be described in detail with reference to the drawings. It should be noted that the embodiment is not intended to limit the scope of the invention. In the drawings, like numerals indicate like or corresponding components as appropriate.

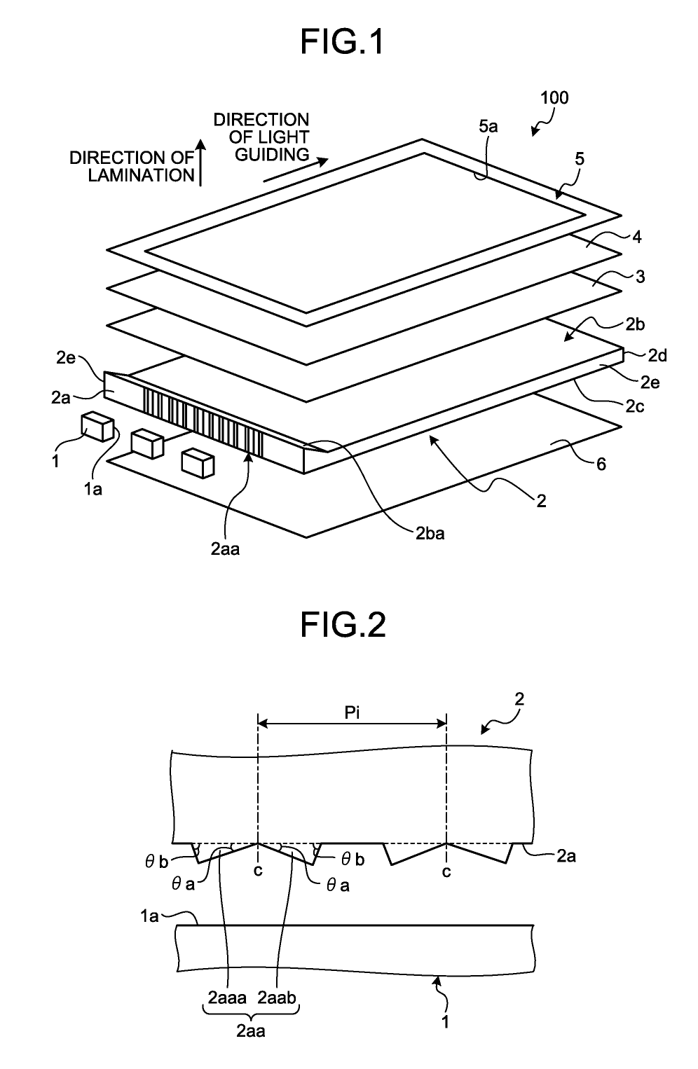

FIG. 1 is an exploded perspective view schematically illustrating the planar illumination device according to the embodiment. A planar illumination device 100 is in a rectangular shape in a top view and includes a plurality of light sources 1, a light guide plate 2, a light diffusion sheet 3, an optical sheet 4, a light-shielding member 5 serving as a fixing member, and a reflection sheet 6. These components configuring the planar illumination device 100 are accommodated in a frame (not illustrated), which is a frame-like member made of resin or the like, and/or supported by the frame. Each of the components is fixed to the frame with a double sided tape or the like and supported.

Examples of the light source 1 include a white LED serving as a point light source, and the light source 1 emits a light from a luminescent surface 1a. The light source 1 is mounted on a wiring substrate (not illustrated) for supplying power to the light source 1. FIG. 1 illustrates three light sources 1; however, the number of light sources 1 may be larger than three.

The light guide plate 2 is made of a member (for example, resin) translucent to the light emitted from each light source 1. The light guide plate 2 has a light-entering end surface 2a, two main surfaces including a light-emission surface 2b and a back surface 2c, an opposite end surface 2d, and two side end surfaces 2e. A plurality of light sources 1 is separated from one another and aligned, for example, at regular intervals with respective luminescent surfaces 1a facing the light-entering end surface 2a. The light emitted from each light source 1 enters the light-entering end surface 2a. The light-emission surface 2b and the back surface 2c intersect (perpendicularly, in this embodiment) with the light-entering end surface 2a and face each other. The opposite end surface 2d is an end surface positioned opposite to the light-entering end surface 2a in a manner facing the light-entering end surface 2a in parallel. The two side end surfaces 2e are end surfaces each intersecting (perpendicularly, in this embodiment) with the light-entering end surface 2a, the light-emission surface 2b, the back surface 2c, and the opposite end surface 2d and facing each other in parallel.

The light guide plate 2 guides a light entering from the light-entering end surface 2a toward a direction of light guiding in FIG. 1, that is, toward the opposite end surface 2d and emits the light from the light-emission surface 2b in a planar manner. Furthermore, an inclined area 2ba is formed in the light-entering end surface 2a side of the light-emission surface 2b in such a manner that the thickness (the distance between the light-emission surface 2b and the back surface 2c) of the light guide plate 2 gradually becomes smaller toward the opposite end surface 2d. In the area excluding the area where the inclined area 2ba is formed, the light-emission surface 2b and the back surface 2c are substantially parallel to each other, and the thickness of the light guide plate 2 is substantially constant. The light guide plate 2 does not necessarily have the inclined area 2ba. For example, the thickness of the light guide plate 2 may be substantially constant from the light-entering end surface 2a to the opposite end surface 2d. Furthermore, a plurality of first prisms and second prisms for diffusing emitted light are formed on the light-emission surface 2b, which will be later described in detail.

The light diffusion sheet 3 is made of a member (for example, resin) for diffusing a light emitted from each light source 1 and diffuses a light emitted from the light-emission surface 2b of the light guide plate 2. The light diffusion sheet 3 is disposed in a direction (a direction of lamination in FIG. 1) perpendicular to the light-emission surface 2b.

The optical sheet 4 is disposed in a direction of lamination on the light diffusion sheet 3. The optical sheet 4 has a function of controlling distribution of the light emitted from the light-emission surface 2b of the light guide plate 2 and diffused by the light diffusion sheet 3. Examples of the optical sheet 4 include a prism sheet. In this embodiment, a sheet as an integrated structure of two prism sheets is used for the optical sheet 4. In another case, the optical sheet 4 may be configured with a laminate of two separate prism sheets.

The light-shielding member 5 serving as a fixing member has a function of integrating (fixing) each member configuring the planar illumination device 100. In the case that the planar illumination device 100 is used as a backlight of a liquid crystal display panel, the light-shielding member 5 functions to integrate the planar illumination device 100 and the liquid crystal display panel as necessary. The light-shielding member 5 (as a feature of a fixing member) is made of a material shielding a light emitted from each light source 1 and has a light-shielding property. The light-shielding member 5 is in the shape of a frame having an opening 5a and is disposed in a direction of lamination on the optical sheet 4 in such a manner that covers the peripheral edge area of the optical sheet 4 (and the peripheral edge area of the light diffusion sheet 3 and the peripheral edge area of the light-emission surface 2b). The light-shielding member 5 covers at least an area in the light-entering end surface 2a side of the light-emission surface 2b of the light guide plate 2. The light-shielding member 5 defines an effective area of the light-emission surface 2b of the light guide plate 2 using the opening 5a. The effective area is an area excluding “a non-effective area” that is inevitably caused in the peripheral edge area of the light-emission surface 2b of the light guide plate 2 when, for example, evenness of an emitted light is reduced due to, for example, the effect of light reflected on the side end surfaces 2e of the light guide plate 2.

The light-shielding member 5 is, in the light-entering side, attached to the frame, a part of the wiring substrate, a part of the light diffusion sheet 3, and a part of the optical sheet 4 from behind the direction of light guiding, thereby integrating these members. The light-shielding member 5 is not limited to the shape of a frame and may be formed in a strip with main functions of, for example, fixing members disposed in the light-entering side and defining an effective area in the light entering side. Instead of using the light-shielding member 5, the fixing member may be configured with, for example, an optically-permeable double sided tape (another aspect of the fixing member) having a main function of fixing without having functions of shielding a light or defining an effective area.

The reflection sheet 6 is provided on the back surface 2c of the light guide plate 2. The reflection sheet 6 has a function of reflecting a light emitted from each light source 1 and arriving at the back surface 2c through the inside of the light guide plate 2 back to the inside of the light guide plate 2. The light-emission surface 2b is therefore the only surface for emitting light in the light guide plate 2 of this embodiment. With this configuration, the light supposed to be emitted from the back surface 2c side is emitted from the light-emission surface 2b, which can increase the efficiency of using a light emitted from each light source 1 as an illumination light. A pattern such as a convex dot pattern for increasing the efficiency of light emission from the light-emission surface 2b is formed on the back surface 2c.

A plurality of light-entering prisms 2aa is formed on the light-entering end surface 2a. The light-entering prism 2aa is used for having a light of the light source 1 incident to the inside of the light guide plate 2 from the light-entering end surface 2a side proceed in a direction parallel to the light-emission surface 2b of the light guide plate 2 in desired light distribution.

FIG. 2 is an illustrative top view of the light source and the light-entering end surface and the light-entering prism of the light guide plate. The light-entering prism 2aa is formed in a manner extending in a direction (the lateral direction of the light-entering end surface 2a) of the thickness of the light guide plate 2. The light-entering prism 2aa is configured with a fourth prism including a unit light-entering prism 2aaa and another unit light-entering prism 2aab of reflective symmetry about a symmetry plane c. A plurality of light-entering prisms 2aa is formed along the light-entering end surface 2a of the light guide plate 2. The symmetry plane c is a surface parallel to the lateral direction of the light-entering end surface 2aa and perpendicular to the light-entering end surface 2a. Each of the unit light-entering prism 2aaa and the unit light-entering prism 2aab has a first incident surface having a smaller inclination angle θa to the light-entering end surface 2a and a second incident surface having a larger inclination angle θb to the light-entering end surface 2a. The first incident surface has a light of the light source 1 proceed in a direction substantially perpendicular to the light-entering end surface 2a, whereas the second incident surface has a light of the light source 1 proceed in a direction substantially parallel to the light-entering end surface 2a. With this configuration, the light-entering prism 2aa has a function of refracting a part of light incident from the light source 1 onto the light-entering end surface 2a in a direction substantially parallel to the light-entering end surface 2a.

In this embodiment, a pitch Pi between the light-entering prisms 2aa next to each other may be about a distance in which a plurality (for example, several to several tens of light-entering prisms 2aa) of light-entering prisms 2aa is aligned in front of the luminescent surface 1a of each light source 1. The light-entering prisms 2aa may be provided over the whole length of the light-entering end surface 2a in the longitudinal direction or may be discretely provided in a manner corresponding to each light source 1.

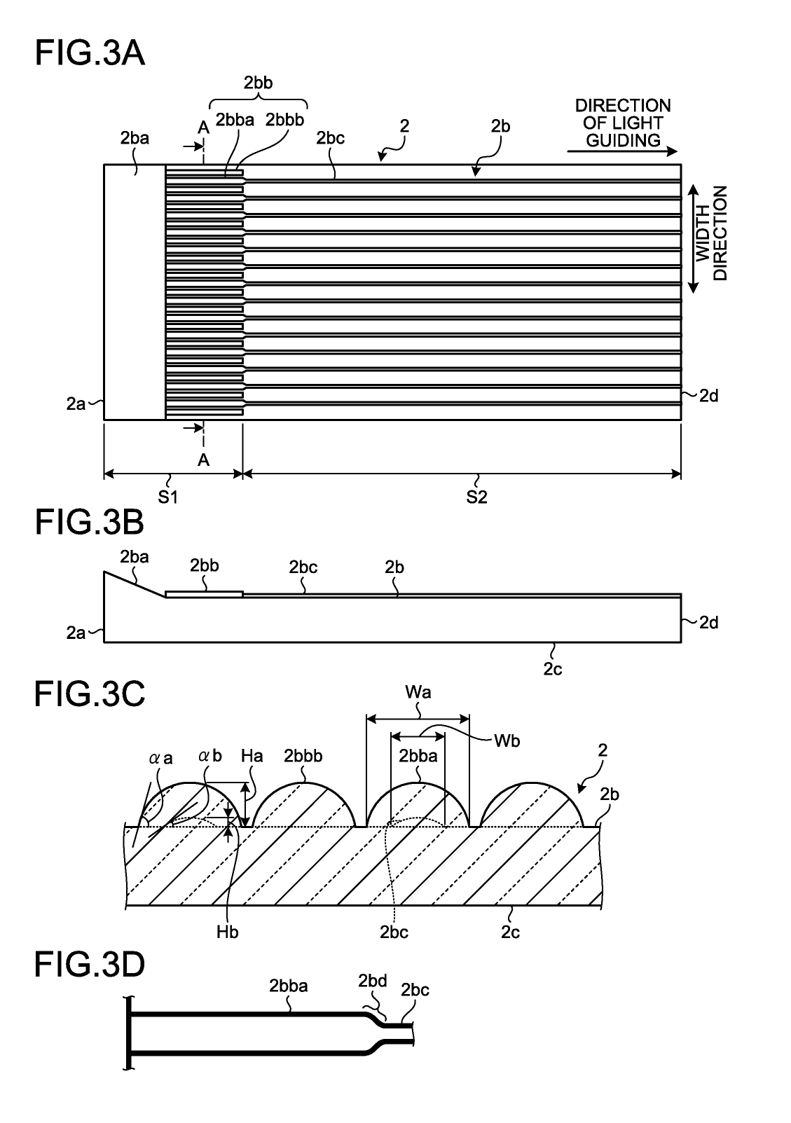

A plurality of first prisms and a plurality of second prisms formed on the light-emission surface 2b will now be described. FIGS. 3A to 3D are illustrative views of the first prism and the second prism. FIG. 3A is a top view of the light guide plate 2. FIG. 3B is a side view of the light guide plate 2. FIG. 3C is a cross-sectional view of a main portion of the light guide plate 2 along the A-A line in FIG. 3A. FIG. 3D is an enlarged partial top view of the first prism and the second prism.

As illustrated in FIGS. 3A and 3B, a plurality of first prisms 2bb is formed in an area Si as a non-effective area covered by the light-shielding member 5 and provided in the light-entering end surface 2a side on the light-emission surface 2b in such a manner that extends toward the opposite end surface 2d at certain intervals. In this embodiment, no first prisms 2bb are formed on an inclined area 2ba. The first prisms 2bb are formed on an area on the light-emission surface 2b where the thickness of the light guide plate 2 is substantially constant. A plurality of second prisms 2bc is formed on an area S2 provided in the opposite end surface 2d side with respect to the area S1 in such a manner that extends towards the opposite end surface 2d at certain intervals. As illustrated in FIG. 3A, each of the second prisms 2bc is connected with any of the first prisms 2bb in a direction (prism extending direction) in which the prism extends. To distinguish between the first prisms 2bb, the first prism 2bb connected with the second prism 2bc will be particularly referred to as a first prism 2bba, whereas the first prism 2bb not connected with the second prism 2bc will be referred to as a first prism 2bbb. In this embodiment, the first prism 2bba and the first prism 2bbb are alternately aligned in the width direction. The number (density) of second prisms 2bc per unit length in the width direction of the light guide plate 2 is thus smaller than the number (density) of first prisms 2bb per unit length in the width direction. More specifically, the density of the second prism 2bc is about a half of that of the first prism 2bb. The first prism 2bb and the second prism 2bc each are actually formed in higher density than the density illustrated in FIG. 3A; however, these prisms are partially omitted in FIG. 3A for easy illustration.

As illustrated in FIG. 3C, in the cross-section perpendicular to the prism extending direction, the first prism 2bb and the second prism 2bc each have cylindrical outer edges with certain radii of curvature. In this embodiment, the radius of curvature of the first prism 2bb is equal to that of the second prism 2bc in the cross-section. In the cross-section perpendicular to the prism extending direction, the width Wb, the height Hb, and the maximum tangent inclination angle αb of the second prism 2bc are smaller than the width Wa, the height Ha, and the maximum tangent inclination angle αa of the first prism 2bb, respectively, which means Wa>Wb, Ha>Hb, and αa>αb. In other words, the size of the second prism 2bc is smaller than that of the first prism 2bb. Furthermore, the width Wa, the height Ha, and the maximum tangent inclination angle αa of the first prism 2bb are each substantially constant in the extending direction. Likewise, the width Wb, the height Hb, and the maximum tangent inclination angle αb of the second prism 2bc prism are each substantially constant in the extending direction.

In each prism, the width of a prism represents the maximum value in the width of the prism. The height of a prism represents the maximum value in the height of the prism from the light-emission surface 2b. The maximum tangent inclination angle of a prism represents the maximum value in the angle of inclination between a tangent line to the outer edge of the prism and the light-emission surface 2b in the cross-section perpendicular to the prism extending direction.

In this embodiment, as illustrated in FIG. 3D, the light guide plate 2 further has third prisms 2bd. The third prism 2bd is interposed between the first prism 2bba and the second prism 2bc connected with each other. In the cross-section perpendicular to the prism extending direction, the third prism 2bd has a width, a height, and a maximum tangent inclination angle continuously varying from the width Wa, the height Ha, and the maximum tangent inclination angle αa of the first prism 2bba to the width Wb, the height Hb, and the maximum tangent inclination angle αb of the second prism 2bc.

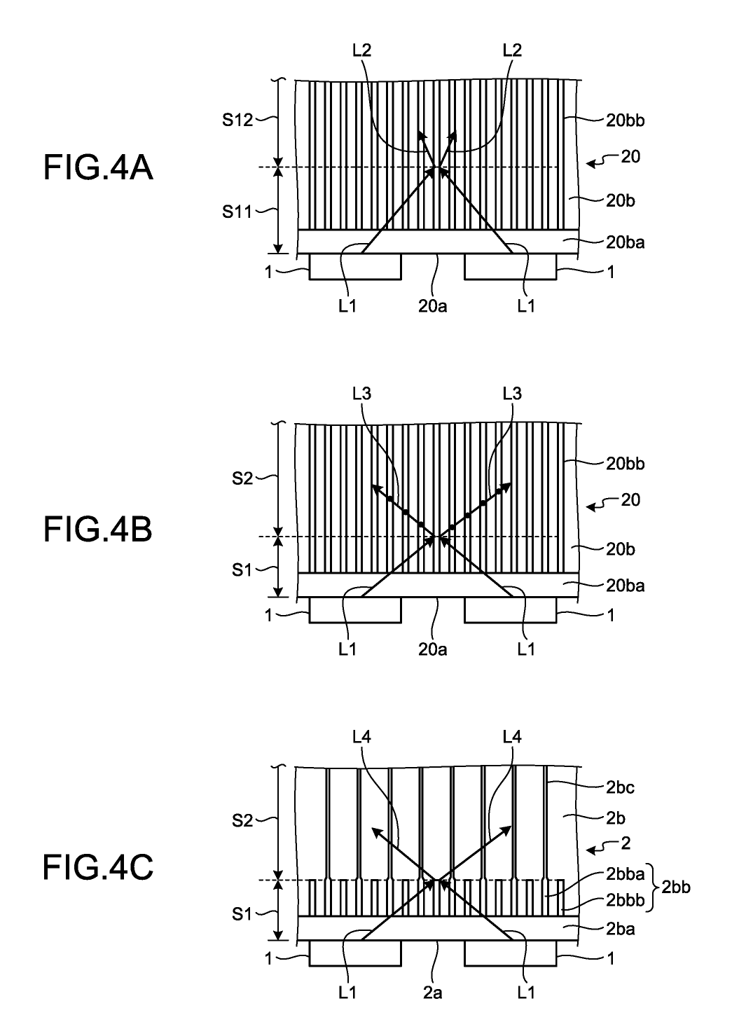

A reason why a high brightness area in a cross shape is generated in a conventional technique and an advantageous effect of preventing the generation in this embodiment will now be described with reference to FIGS. 4A to 4C. FIG. 4A is an illustrative view of light paths of incident light L1 from each of the light sources 1 in the case of using a light guide plate 20 in a conventional technique. The light guide plate 20 has a light-entering end surface 20a with a light-entering prism (not illustrated) formed thereon and a light-emission surface 20b. The light-entering end surface 20a has a plurality of light sources 1 including illustrated two light sources 1. The light-emission surface 20b includes thereon an inclined area 20ba and cylindrical prisms 20bb for diffusing light with an outer edge having a certain radius of curvature in the cross-section perpendicular to the prism extending direction. An area S11 is a non-effective area covered by a shielding member, whereas an area S12 is an area arranged in the opposite end surface side with respect to the area S11 and including an effective area.

Incident light from the light source 1 onto the light-entering end surface 20a of the light guide plate 20 is moved forward by the light-entering prism in desired light distribution. The light L1 represents a part of incident light from the light source 1. The light path of the incident light is bent due to total reflection of the light on the prism 20bb (the light L1 with its light path bent is indicated by a light L2 in FIG. 4A). The total reflection of the incident light on the prism 20bb is caused a plurality of times in the area S12 and also in the area S11, and the light is incrementally emitted outside while proceeding in various directions. With this mixing effect, unevenness in brightness such as a dark spot is less likely to be caused between the light sources 1 (more specifically, in the area between areas positioned in front of the respective light sources 1 in the area S11).

If a frame width reduction is implemented on the configuration of FIG. 4A by having the area S11 as small as the area S1 and the area S12 as large as the area S2, which results in the configuration in FIG. 4B, this process decreases the distance from the light source 1 to the boundary between the effective area and the non-effective area indicated by a dashed line. In this case, in order to eliminate unevenness in brightness, the angle of a light-entering prism of the light-entering end surface 20a is adjusted such that the light L1 further widens in the width direction compared with the light L1 in the configuration of FIG. 4A.

However, if the light L1 proceeds in a manner further widening in the width direction as illustrated in FIG. 4B, this configuration decreases the incident angle of the light L1 to the side surface of the prism 20bb. If the angle is smaller than a critical angle, the light L1 is not totally reflected on the prism 20bb. The light L1 proceeds on a straight line as indicated by a light L3 or proceeds while being incrementally refracted by each prism 20bb, which increases the amount of light emitted outside by each prism 20bb. This process causes a bright spot as indicated by a black circle on each prism 20bb. The bright spots are observed as a continuous high brightness area in a cross shape when viewed from above. The high brightness area in a cross shape is formed in a manner starting from the light sources 1.

The planar illumination device 100 according to the embodiment has the first prisms 2bb formed in the area S1 on the light-emission surface 2b of the light guide plate 2 as illustrated in FIG. 4C. Similarly to the configuration of FIG. 4A, this configuration can eliminate unevenness in brightness such as a dark spot caused between the light sources 1. Furthermore, the density of the second prism 2bc formed in the area S2 in the width direction is smaller than the density of the first prism 2bb in the width direction. The width Wb, the height Hb, and the maximum tangent inclination angle αb of the second prism 2bc are smaller than the width Wa, the height Ha, and the maximum tangent inclination angle αa of the first prism 2bb, respectively. Similarly to the light L3, this configuration renders the light L1 to proceed in a manner indicated by the light L4. However, the configuration can prevent the generation of bright spots illustrated in FIG. 4B or can reduce the number of bright spots even if they are generated. The planar illumination device 100 according to the embodiment therefore exerts advantageous effects of reducing the frame width and preventing the generation of a high brightness area in a cross shape.

Furthermore, the planar illumination device 100 according to the embodiment has each of the second prisms 2bc connected with a corresponding first prism 2bba, which prevents the end of the second prism 2bc from being exposed from the light-entering end surface 2a side. This configuration prevents incident light from the light source 1 from contacting with the end of the second prism 2bc and thus being emitted, which can accordingly prevent the generation of bright spots.

In the embodiment, the third prism 2bd is interposed between the first prism 2bba and the second prism 2bc connected with each other. The third prism 2bd has a width, a height, and a maximum tangent inclination angle continuously varying from the width Wa, the height Ha, and the maximum tangent inclination angle αa of the first prism 2bba to the width Wb, the height Hb, and the maximum tangent inclination angle αb of the second prism 2bc. With this configuration, no discontinuous shapes are formed at the connection point between the first prism 2bba and the second prism 2bc different in size from each other, which is much less likely to cause bright spots. The third prism 2bd is, however, not necessarily provided. Even with no third prisms 2bd, the configuration exerts advantageous effects of reducing the frame width and preventing the generation of a high brightness area in a cross shape.

Method of Fabrication

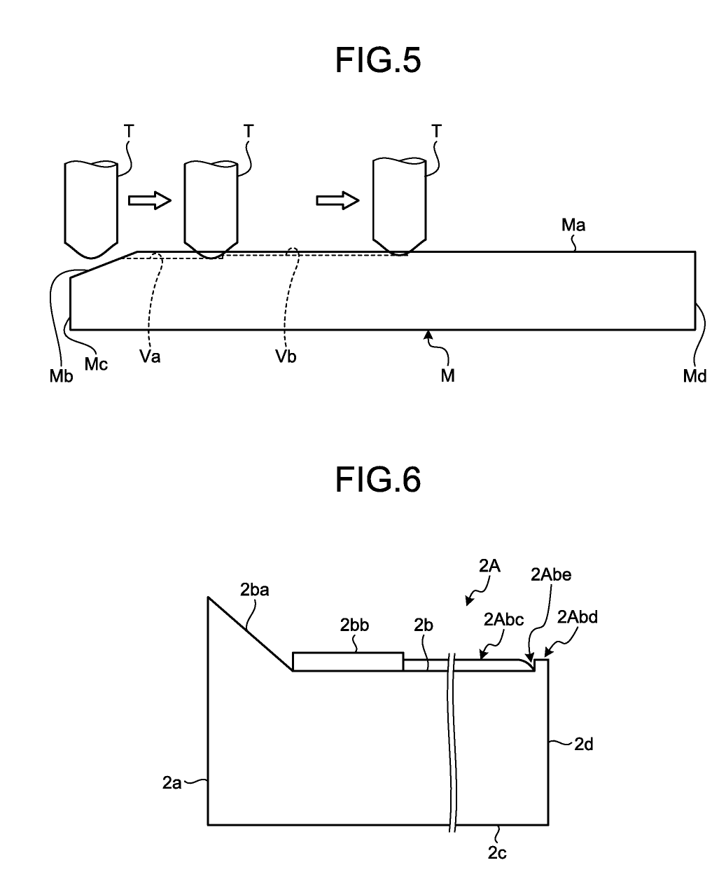

An exemplary method of fabricating the light guide plate 2 of the planar illumination device 100 according to the embodiment will now be described. The light guide plate 2 can be made, for example, by the injection compression molding. The mold used for the injection compression molding can be made by the method illustrated in FIG. 5.

In particularly fabricating a molding member M of the mold for forming a structural portion in the light-emission surface 2b side of the light guide plate 2, the molding member M having a molding surface Ma for forming the light-emission surface 2b is first prepared. An inclined surface Mb for forming the inclined area 2ba of the light-emission surface 2b is formed on the molding surface Ma. A cutting tool T is pressed against the inclined surface Mb of the molding member M and is moved from an end surface Mc side having the inclined surface Mb to another end surface Md opposite to the end surface Mc along the molding surface Ma. The tip of the cutting tool T has a certain radius of curvature. The molding member M is accordingly cut, and a cylindrical groove Va having a certain radius of curvature in the cross-section perpendicular to the page and parallel to the longitudinal direction of the page is formed on the molding surface Ma. The groove Va is a groove for forming the first prism 2bb. In this process, by adjusting the height of the cutting tool T with respect to the molding surface Ma, the groove Va is formed in a shape with which the width Wa, the height Ha, and the maximum tangent inclination angle αa of the first prism 2bb are obtained.

If the groove Va is a groove particularly for forming the first prism 2bba, the cutting tool T is moved toward the end surface Md side while gradually being pulled upward after formation of the groove Va. The pulling operation is stopped when the cutting tool T has been pulled by a certain amount. By continuously moving the cutting tool T toward the end surface Md side after completion of pulling of the cutting tool T, such a cylindrical groove Vb is formed on the molding surface Ma that has a certain radius of curvature in the cross-section perpendicular to the page and parallel to the longitudinal direction of the page. The groove Vb is a groove for forming the second prism 2bc. In this process, by adjusting the height level of the cutting tool T, the groove Vb is formed in a shape with which the width Wb, the height Hb, and the maximum tangent inclination angle αb of the second prism 2bc are obtained. Another groove (not illustrated) for forming the third prism 2bd is formed between the groove Va and the groove Vb. The groove for forming the third prism 2bd is easily formed by moving the cutting tool T toward the end surface Md side while gradually pulling the tool upward.

If the groove Va is a groove particularly for forming the first prism 2bbb, the cutting tool T is pulled upward after formation of the groove Va, and the groove forming operation is completed.

The second prism 2bc and the first prism 2bba are connected with each other on the light guide plate 2. Because of this configuration, the grooves Va and Vb are successively formed in a single process only by adjusting the height level of the cutting tool T while moving the cutting tool T from the end surface Mc side toward the end surface Md side in fabricating the molding member M. This method can reduce the time for fabricating the molding member M. The light guide plate 2 can be therefore made more easily and at a lower cost, thereby reducing the price of the light guide plate 2 made. If the second prism 2bc and the first prism 2bbb are not connected with each other, separate processes are necessary, which include a process of pressing the cutting tool T against the inclined surface Mb and moving the cutting tool T from the end surface Mc side toward the end surface Md side for forming the groove Va and the other process for pressing the cutting tool T against the end surface Md side and moving the cutting tool T from the end surface Md side toward the end surface Mc side for forming the groove Vb. This method increases the time for fabricating the molding member. In cutting the molding member M with the cutting tool T, the cutting tool T needs to be pressed against the side surface of the molding member M in starting cutting. This is to prevent breakage or the like of the cutting tool T, which is likely to be caused by pressing the cutting tool perpendicularly against the molding surface Ma of the molding member M. With this reason, the grooves Va and Vb are separately formed.

Another embodiment of the light guide plate

FIG. 6 is an illustrative side view of the light guide plate in another embodiment. With respect to the configuration of the light guide plate 2 in FIGS. 3A to 3D and others, a light guide plate 2A illustrated in FIG. 6 is configured in such a manner that replaces the second prism 2bc with a second prism 2Abc and provides a projecting portion 2Abd on the light-emission surface 2b. The second prism 2Abc has its height monotonically decrease in the opposite end surface 2d side along the direction of light guiding. The projecting portion 2Abd is provided in the opposite end surface 2d side of the second prism 2Abc. With this configuration, a concave portion 2Abe is formed between the projecting portion 2Abd and the second prism 2Abc, and the projecting portion 2Abd and the concave portion 2Abe are formed in pairs.

In this case, the thickness of the light guide plate 2A along the opposite end surface 2d is desirably defined by the projecting portion 2Abd and the concave portion 2Abe, and the thickness can be thus set in an appropriate range. In the case of forming the light guide plate 2A by the injection compression molding, the projecting portion 2Abd can be configured by utilizing burr generated along the opposite end surface 2d of the light guide plate 2A (see Japanese Patent Application No. 2014-210850 unpublished as of application of the present invention by the applicant of the present invention). This configuration allows the thickness of the light guide plate 2A along the opposite end surface 2d to be set in an appropriate range using the projecting portion 2Abd. The peripheral edge portions of the light diffusion sheet 3 and the optical sheet 4 laminated on the light-emission surface 2b of the light guide plate 2A are less likely to be projected in a direction of lamination with an increase in the thickness of the light guide plate 2A along the opposite end surface 2d. Even if the light diffusion sheet 3 and the optical sheet 4 are slightly projected, the amount of projection can be reduced, which can eliminate disadvantageous effects caused by the burr.

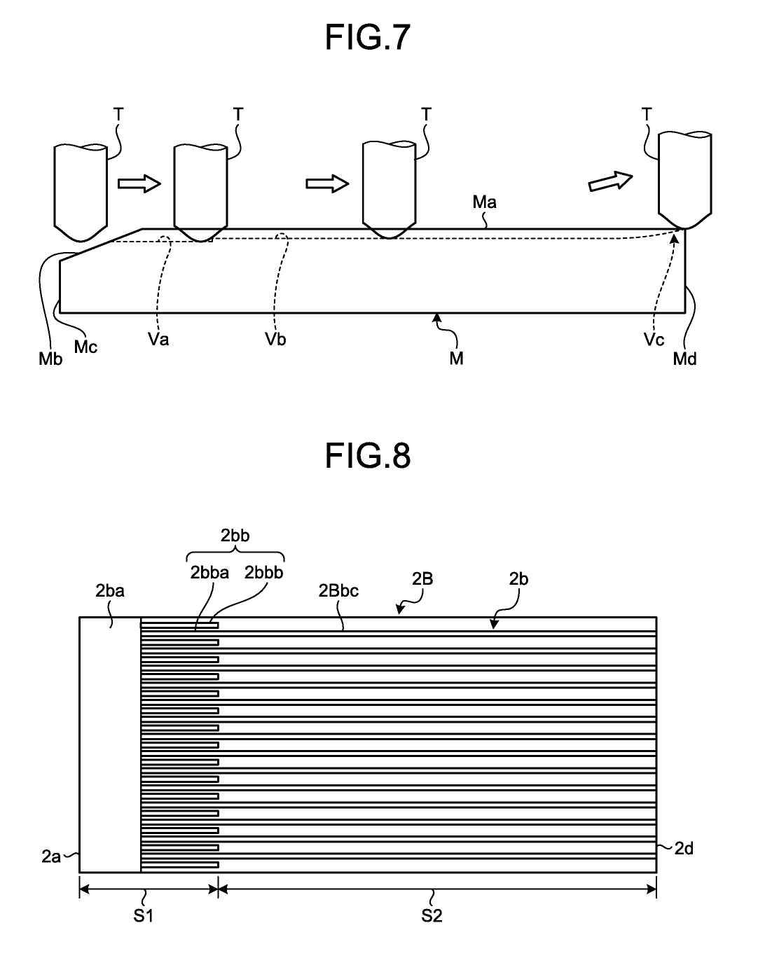

The molding member used for fabricating the light guide plate 2A by the injection compression molding is made by the method illustrated in FIG. 7. The method of fabrication illustrated in FIG. 7 is substantially the same as the method of fabrication illustrated in FIG. 5 with a difference in that the height level of the cutting tool T is gradually increased when the cutting tool T approaches the end surface Md side of the molding member M. By gradually increasing the height level of the cutting tool T, such a groove Vc is formed that has a depth gradually decreased toward the end surface Md side. The groove Vc and the end surface Md form the portion where the height of the second prism 2Abc is monotonically decreased, the projecting portion 2Abd, and the concave portion 2Abe.

Still another embodiment of the light guide plate

FIG. 8 is an illustrative top view of the light guide plate in still another embodiment. With respect to the configuration of the light guide plate 2 in FIGS. 3A to 3D and others, a light guide plate 2B illustrated in FIG. 8 is configured in such a manner that replaces the second prism 2bc with a second prism 2Bbc. The second prism 2Bbc has the same radius of curvature, width, height, and maximum tangent inclination angle as those of the first prism 2bb in the cross-section. In this configuration, although the second prism 2Bbc has the same radius of curvature, width, height, and maximum tangent inclination angle as those of the first prism 2bb in the cross-section, which means that the second prism 2Bbc and the first prism 2bb are in the same shape, there is a difference in that the density of the second prism 2Bbc formed in the area S2 in the width direction is smaller than the density of the first prism 2bb in the width direction. Application of this configuration to the planar illumination device 100 according to the embodiment can therefore reduce the frame width and prevent generation of a high brightness area in a cross shape.

In this embodiment, the width Wa, the height Ha, and the maximum tangent inclination angle αa of the first prism 2bb are substantially constant in the prism extending direction. Likewise, the width Wb, the height Hb, and the maximum tangent inclination angle αb of the second prism 2bc are substantially constant in the prism extending direction. The present invention is not, however, limited to this configuration. Any of the width, height, and maximum tangent inclination angle of the first prism or any of the width, height, and maximum tangent inclination angle of the second prism may vary along the prism extending direction.

Furthermore, in this embodiment, the width Wb, the height Hb, and the maximum tangent inclination angle αb of the second prism 2bc are smaller than the width Wa, the height Ha, and the maximum tangent inclination angle αa of the first prism 2bb. The present invention is not limited to this configuration, and the width Wb, the height Hb, and the maximum tangent inclination angle αb of the second prism 2bc may be equal to or smaller than the width Wa, the height Ha, and the maximum tangent inclination angle αa of the first prism 2bb, which means that the configuration may satisfy: Wa≧Wb, Ha≧Hb, and αa≧αb. In another case, the configuration may satisfy: Wb≧Wa, Hb≧Ha, and αb≧αa.

In this embodiment, a plurality of light-entering prisms 2aa is formed on the light-entering end surface 2a; however, no light-entering prisms may be formed. In the case of using a light guide plate with no light-entering prisms formed on the light-entering end surface, a high brightness area in a cross shape may be problematically generated if incident light from a light source widens in the width direction. The generation can be, however, preferably controlled by applying the configuration of this invention.

In the embodiment, no first prisms 2bb are formed on the inclined area 2ba of the light-emission surface 2b; however, the first prisms 2bb may be formed in a manner extending to the inclined area 2ba.

According to the present invention, a frame width reduction can be achieved, and generation of a high brightness area in a cross shape can be prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A planar illumination device comprising:
a plurality of light sources;
a light guide plate that has a light-entering end surface, two main surfaces and an opposite end surface, a light emitted from each of the plurality of light sources entering the light-entering end surface, the two main surfaces intersecting with the light-entering end surface and facing each other, the opposite end surface facing the light-entering end surface and the light guide plate guiding the light toward the opposite end surface and emitting the light from a light-emission surface that is one of the two main surfaces; and
a fixing member that is disposed in such a manner that covers at least an area in the light-entering end surface side of the light-emission surface of the light guide plate, wherein
the light guide plate has a plurality of first prisms and a plurality of second prisms, the plurality of first prisms being formed on the light-emission surface of the light guide plate in such a manner that extends toward the opposite end surface in an area covered by the fixing member in the light-entering end surface side and the plurality of second prisms being formed on the light-emission surface of the light guide plate in such a manner that extends toward the opposite end surface in an area in the opposite end surface side with respect to the area covered by the fixing member in the light-entering end surface side,
number of the plurality of second prisms per unit length in a width direction of the light guide plate is smaller than number of the plurality of first prisms per unit length in the width direction, and
each of the plurality of second prisms is connected with any of the plurality of first prisms in a prism extending direction.

2. The planar illumination device according to claim 1, wherein each of a width, a height, and a maximum tangent inclination angle of each of the plurality of second prisms in a cross-section perpendicular to the prism extending direction, is equal to or smaller than a width, a height, and a maximum tangent inclination angle, respectively, of each of the plurality of first prisms.

3. The planar illumination device according to claim 1, wherein any of a width, a height, and a maximum tangent inclination angle of each of the plurality of first prisms or any of a width, a height, and a maximum tangent inclination angle of each of the plurality of second prisms in a cross-section perpendicular to the prism extending direction varies along the prism extending direction.

4. The planar illumination device according to claim 1, wherein the light guide plate has a plurality of third prisms, the plurality of third prisms being interposed between the plurality of first prisms and the plurality of second prisms connected with each other and a width, a height, or a maximum tangent inclination angle of the plurality of third prisms in a cross-section perpendicular to the prism extending direction continuously varying, from a width, a height, or a maximum tangent inclination angle of the plurality of first prisms to a width, a height, or a maximum tangent inclination angle of the plurality of second prisms.

5. The planar illumination device according to claim 1, wherein
the light guide plate has an inclined area formed in the light-entering end surface side such that a thickness becomes smaller toward the opposite end surface, and
the plurality of first prisms is formed in a manner extending to the inclined area.

6. The planar illumination device according to claim 1, wherein each of the plurality of second prisms has a height monotonically decreasing along the prism extending direction in the opposite end surface side, and has a projecting portion in the opposite end surface side of the plurality of second prism.

7. The planar illumination device according to claim 1, wherein the fixing member is a light-shielding member having a light-shielding property.

8. The planar illumination device according to claim 1, comprising a plurality of fourth prisms that is formed on the light-entering end surface and refracts a part of incident light onto the light-entering end surface in a direction substantially parallel to the light-entering end surface.
